(19) United States
(12) Patent Application Publication
(10) Pub. No.: US 2006/0283285 A1
(43) Pub. Date: Dec. 21, 2006

(54) Operation mechanism

(76) Inventors: Hiroyuki Yabashi, Tokyo (JP); Satoru Yamamoto, Tokyo (JP)

Correspondence Address: BIRCH STEWART KOLASCH & BIRCH, PO BOX 747, FALLS CHURCH, VA, 22040-0747, US

(21) Appl. No.: 10/572,475

(22) PCT Filed: Jun. 7, 2005
(86) PCT No.: PCT/JP05/10418

§ 371 Date: Mar. 17, 2006

(30) Foreign Application Priority Data
Aug. 27, 2004 (JP) 2004 248875

(51) Int. Cl. G05G 1/10

(52) U.S. Cl. 74/553

(57) ABSTRACT

An operation unit includes a shaft-side operation member 6 attached to the above-mentioned operating shaft 3, an auxiliary operation member 7 which is fitted into and engaged with the above-mentioned shaft-side operation member 6 via an engagement means 7a for releasing engagement between the shaft-side operation member and the auxiliary operation member when shocked, and which constitutes the single operation unit together with the shaft-side operation member, and a boundary portion 8 disposed between the above-mentioned operation members with being exposed to outside the above-mentioned front panel when the above-mentioned shaft-side operation member 6 is attached to the above-mentioned operating shaft 3 while being combined with the above-mentioned auxiliary operation member 7.

### FIELD OF THE INVENTION

The present invention relates to an operation system which is disposed in a front panel of equipment, such as audio equipment for vehicles or a DVD player, and which can absorb a shock applied thereto.

### BACKGROUND OF THE INVENTION

In order to obtain an improvement in safety for passengers on front seats in the event of a crash, standards are defined for various electrical components which can be built into a front panel disposed within the cabin so that any projecting object, such as an operation unit, does not expose human bodies to danger in the event of a crash, and various kinds of ideas for safety in the event of a crash have been made.

For example, (1) structure in which a part to be damaged is disposed in a rotating knob, and, when a large force is imposed on the rotating knob, the part to be damaged is crushed and the rotating knob is made to move (for example, refer to patent reference 1); (2) structure in which a penetrating shaft hole which is fitted into a shaft projecting from an electronic component is disposed, and a shock absorption member which can be destroyed by a collision with the tip part of the above-mentioned shaft is formed within the interior of the penetrating shaft hole (for example, refer to patent reference 2); and (3) structure in which a rib which is deformed or ruptured by a predetermined thrust is disposed in a fitting hole of an operation unit (for example, refer to patent reference 3) have been proposed.

[Patent reference 1] JP,2001-189116,A

[Patent reference 2] JP,2001-266704,A

[Patent reference 3] JP,11-189072,A

Although each of these related art operation units has a common structure for enabling a predetermined part thereof to be damaged in the event of a crash so as to reduce the amount of projection of a related art operation unit, since only a main part of the related art operation unit is exposed to outside the front panel, the outward appearance of the related art operation unit is forced to be monotonous, lacks visual novelty, and is inadequate for arousing consumers' appetite for buying.

The present invention is made in order to solve the above-mentioned problem, and it is therefore an object of the present invention to provide an operation system which can assure design novelty technically while taking into consideration safety for passengers in the event of a crash.

### DISCLOSURE OF THE INVENTION

An operation system in accordance with the present invention includes a shaft-side operation member attached to an operating shaft, an auxiliary operation member which is fitted to and engaged with an outer surface of the above-mentioned inner operation member via an engagement means for releasing engagement between the shaft-side operation member and the auxiliary operation member when shocked, and which constitutes the single operation unit together with the shaft-side operation member, and a boundary portion disposed between the above-mentioned operation members with being exposed to outside the above-mentioned front panel when the above-mentioned shaft-side operation member is attached to the above-mentioned operating shaft while being combined with the above-mentioned auxiliary operation member.

As a result, since a relative displacement occurs in a positional relationship between the shaft-side operation member and the auxiliary operation member and the amount of projection of the operation unit is reduced when shocked, while the passenger safety is ensured, the design novelty is collateralized technically since the boundary portion between the shaft-side operation member and the auxiliary operation member is disposed so as to be exposed to passengers' vision.

### BRIEF DESCRIPTION OF THE FIGURES

FIG. 1 is a cross-sectional view of an operation unit;

FIG. 2 is a perspective view of the outward appearance of a front panel;

FIG. 3 is a cross-sectional view of the operation unit;

FIG. 4 is a partially sectional perspective view of the operation unit;

FIG. 5 is a partially sectional perspective view of the operation unit;

FIG. 6 is a cross-sectional view of the operation unit;

FIG. 7 is a perspective view of the operating shaft; and

FIG. 8 is a cross-sectional view of the operation unit.

### PREFERRED EMBODIMENTS OF THE INVENTION

Hereafter, in order to explain this invention in greater detail, the preferred embodiments of the present invention will be described with reference to the accompanying drawings.

### Embodiment 1

An operation system according to embodiment 1 of the present invention will be now described.

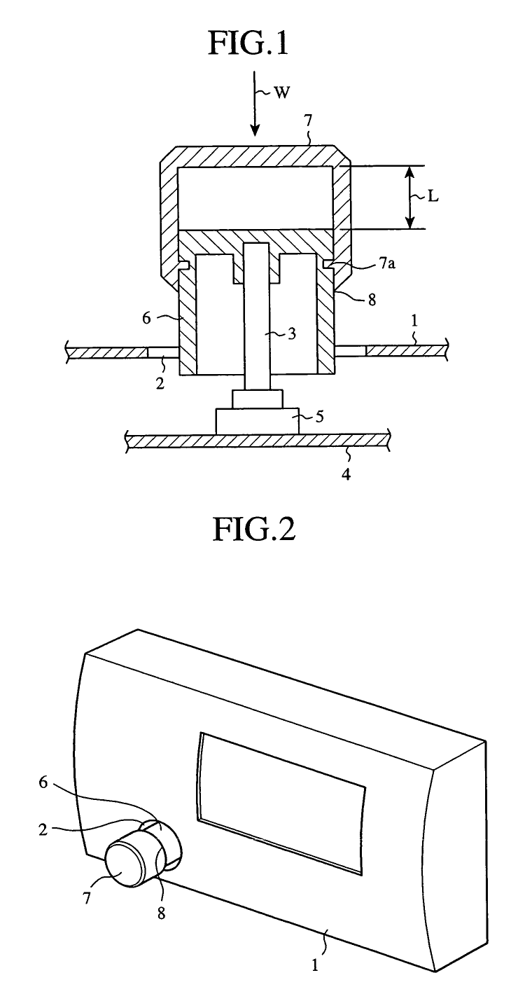

In FIG. 1, an insert hole 2 having an diameter larger than the outer diameter of an operation unit is formed in a front panel 1, and an operating shaft 3 is disposed in this insert hole 2. The operating shaft 3 is integral with operation equipment 5 which is secured to a substrate 4 which is disposed within the front panel 1. The operating shaft 3 can be moved along a direction of the axis thereof, and can be rotated. For example, a push-on encoder can be used as the operation equipment 5. The user is allowed to switch between on and off states by moving the operation unit along the direction of the axis of the operating shaft, or to adjust the volume of audio equipment or the like by rotating the operation unit. The front panel 1 can be a front panel of a vehicle, or can be a panel for electrical components.

A shaft-side operation member 6 having a cylindrical shape is attached to a tip part of the operating shaft 3. In this case, the shaft-side operation member 6 is fixed to the tip part of the operating shaft 3. An auxiliary operation member 7 having a cylindrical shape is fitted to an outer surface of the shaft-side operation member 6, and is engaged with the shaft-side operation member 6 via an engagement means. Next, this engagement means will be explained. Two projections 7a are formed on an inner surface of the auxiliary operation member 7 so as to project toward a diametral direction, and these projections 7a are engaged with holes formed in the outer surface of the shaft-side operation member 6, respectively.

The single operation unit is constituted by the combination of the shaft-side operation member 6 and auxiliary operation member 7 which are placed in this engagement state. The auxiliary operation member 7 has a larger diameter than that of the shaft-side operation member 6, and is easy for the user to hold. Furthermore, the auxiliary operation member 7 is located on a nearer side than the shaft-side operation member 6 when viewed from the user. Therefore, the user holds and manipulates this auxiliary operation member 7. As shown in FIG. 1, a bottom end of the auxiliary operation member 7 constitutes a boundary portion 8 disposed between the shaft-side operation member 6 and the auxiliary operation member 7, and this boundary portion 8 is exposed to outside the front panel 1. In other words, the two members: the shaft-side operation member 6 and auxiliary operation member 7 are exposed to outside the front panel 1.

As shown in FIG. 2, since the boundary portion 8 is exposed to outside the front panel 1, the color of the shaft-side operation member 6 is easily made to differ from that of the auxiliary operation member 7 at the stage of the assembly of the operation unit, for example, and various combinations of beauties can be easily acquired.

A bottom end of the shaft-side operation member 6 is located inside the front panel 1. A certain distance L is secured between a tip part of the shaft-side operation member 6 and an inner bottom surface of the auxiliary operation member 7. When a load W in the direction of the axis of the operating shaft is imposed on the auxiliary operation member 7, the engagement between the shaft-side operation member and the auxiliary operation member is released because the projections 7a are sheared or the auxiliary operation member 7 becomes deformed and the projections 7a run up onto the outer surface of the shaft-side operation member 6.

The operation unit is so constructed that the engagement between the shaft-side operation member and the auxiliary operation member is released when a predetermined load, e.g., a load caused by a shock of 35 kg or more is imposed on the auxiliary operation member 7. Since a force caused by the push with a finger is at most 8 kg, the engagement means is not released as long as the user performs normal operations. When the engagement between the shaft-side operation member and the auxiliary operation member is released, the auxiliary operation member 7 shifts along the shaft-side operation member 6 toward the side of the front panel 1 within a range up to the length L. As a result, since the amount of projection of the operation unit from the front panel 1 decreases, the safety for the human body in the event of a crash increases.

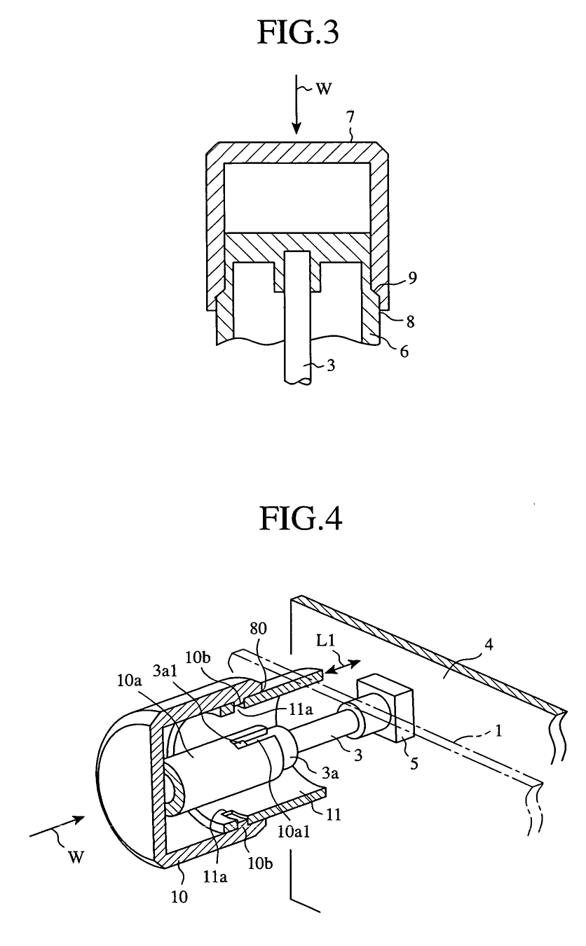

In the example shown in FIG. 1, the engagement unit for making the shaft-side operation member 6 be engaged with the auxiliary operation member 7 is constructed of the projections and holes. As an alternative, the engagement unit can be a tapered surface connected portion 9 constructed of a connection of tapered surfaces, as shown in FIG. 3. In this case, when a load W is imposed on the auxiliary operation member 7, the outer diameter of the auxiliary operation member 7 becomes deformed and hence the engagement between the shaft-side operation member and the auxiliary operation member is released.

### Embodiment 2

In FIG. 4, a front panel 1, an insert hole 2, a substrate 4, and operation equipment 5 are constructed as in the above-mentioned case shown in FIGS. 1 to 3, a tip part of an operating shaft 3 is formed as a cylindrical portion 3a, and this cylindrical portion 3a is fitted into a cylinder 10a which is integral with a shaft-side operation member 10 which is shaped like a cylinder so that the cylindrical portion 3a can be slid in the cylinder 10a. A slit 10a1 is formed in the cylinder 10a so as to extend in a direction of the length of the cylinder 10a. A projection 3a1 projecting from the lateral surface of the cylindrical portion 3a is engaged with this slit 10a1. One or more sets of the projection 3a1 and slit 10a1 which are an engagement means are disposed on the lateral surfaces of the cylindrical portion and cylinder at equal intervals.

An auxiliary operation member 11 which is shaped like a cylinder is fitted into an inner diameter part of the shaft-side operation member 10. Projections 10b project from the inner diameter part of the shaft-side operation member 10. Each of these projections 10b is engaged with a hole 11a formed in the auxiliary operation member 11.

As shown in the figure, when the projection 3a1 is pressed against an inner portion of the slit 10a1 as far as it will go, the user can perform an on/off operation by pushing the shaft-side operation member 10 or can adjust the volume or the like of audio equipment by rotating the shaft-side operation member 10. An end part, which is diagonally shown on a right-hand side of FIG. 4, of the shaft-side operation member 10 constitutes a boundary portion 80 which is disposed between the shaft-side operation member 10 and the auxiliary operation member 11 so that this boundary portion 80 is exposed to outside the front panel 1. That is, the two members: the shaft-side operation member 10 and auxiliary operation member 11 are exposed to outside the front panel 1. The operation system of this embodiment thus provides the same beautiful view as shown in FIG. 3.

There is a gap having a length L1 between a right-hand end part, which is diagonally shown in the figure, of the auxiliary operation member 11, and the substrate 4. When a load W in a direction of the axis of the shaft-side operation member 10 is imposed on the shaft-side operation member 10, the projection 10a1 is sheared and the engagement between the projection and the slit is released, and the shaft-side operation member 10 is then made to move in the direction of the axis thereof together with the auxiliary operation member 11 while being guided by the cylinder 10a. The shaft-side operation member 10 finally collides with the substrate 4 after it has traveled the distance L1. Then, the projections 10b are sheared and the engagement between each of the projections and the corresponding one of the holes is released, and the cylindrical portion 3a stops at a location where it collides with the end of the cylinder 10a. At this time, as shown in FIG. 5, the amount of projection of the operation unit from the front panel 1 is reduced as compared with the case shown in FIG. 4. Instead of the mechanism of making the projection 10a1 and projections 10b be sheared when shocked, the operation system can have a mechanism of making the cylinder 10a and shaft-side operation member 10 corresponding to the projection 10a1 and projections 10b become deformed when shocked so as to release the engagement between the cylinder and the shaft and the engagement between the shaft-side operation member and the auxiliary operation member.

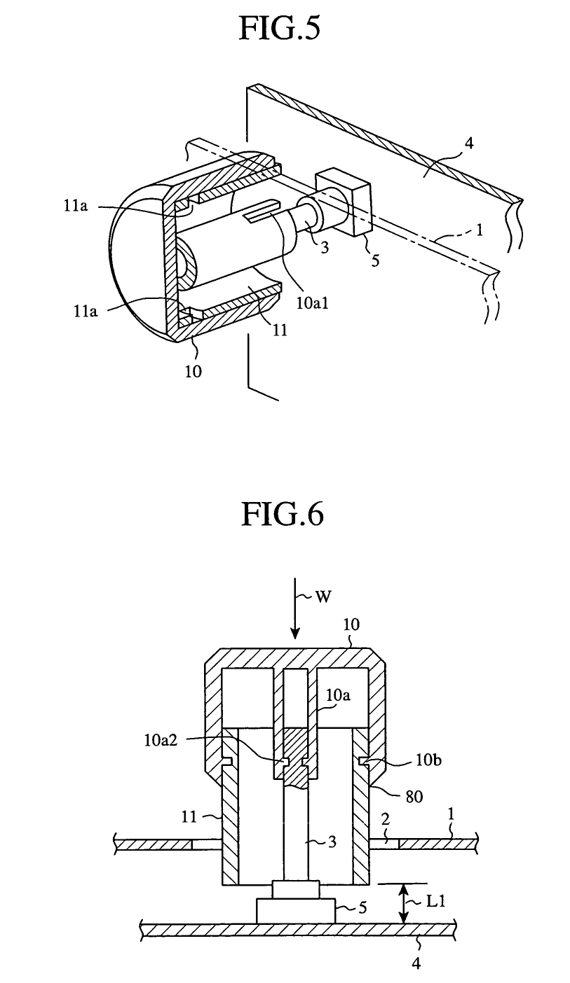

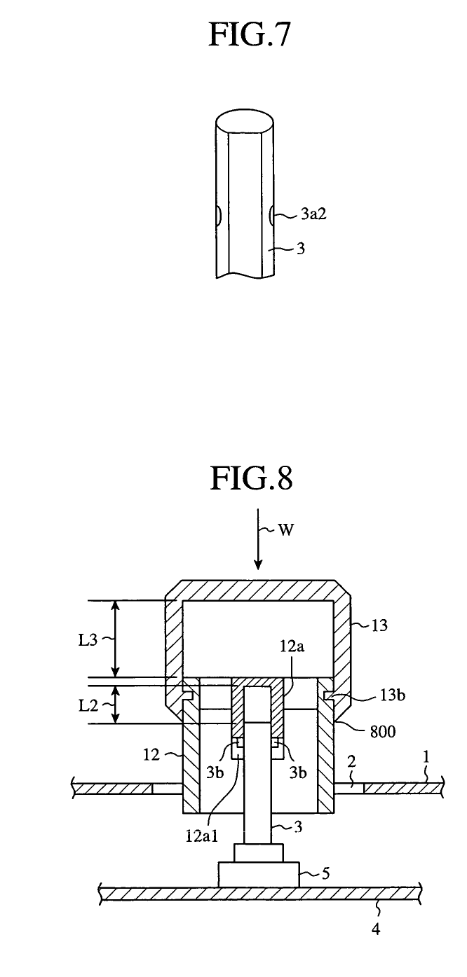

In the example shown in FIGS. 4 and 5, the slit 10a1 and projection 10b are disposed as the engagement means for making the shaft 3be engaged with the cylinder 10a. As an alternative, projections 10a2 which are disposed in the cylinder 10a as shown in FIG. 6 and engaging holes 3a2 which are formed in the shaft 3 as shown in FIG. 7 can be provided as the engagement means. In the example of FIGS. 6 and 7, each of the engaging holes of the shaft 3 is shaped like D in cross section, and is fitted into the cylinder 10a so that it is not rotated. Therefore, each of the projections of the cylinder 10a is D-shaped so as to be engaged with the shaft 3.

### Embodiment 3

In FIG. 8, a front panel 1, an insert hole 2, a substrate 4, and operation equipment 5 are constructed as in the above-mentioned case shown in FIGS. 1 to 3, a tip part of an operating shaft 3 is fitted into a cylinder 12a which is integral with a shaft-side operation member 12 which is shaped like a cylinder so that the operating shaft 3 can be slid in the cylinder 12a. Slits 12a1 are formed in the cylinder 12a so as to extend in a direction of the length of the cylinder 12a. Each of these slits 12a1 has a shape which is similar to that of the above-mentioned slit 10a1. Projections 3b projecting from the lateral surface of the operating shaft 3 are engaged with these slits 12a1, respectively. One or more sets of the projection 3b and slit 12a1 are disposed in the shaft and cylinder at equal intervals.

An auxiliary operation member 13 which is shaped like a cylinder is fitted into an outer diameter portion of the shaft-side operation member 12. Projections 13b project from an inner diameter portion of this auxiliary operation member 13. These projections 13b are engaged with holes formed in the shaft-side operation member 12, respectively.

As shown in the figure, when the projections 3b are pressed against inner portions of the slits 12a1, respectively, as far as they will go, the user can perform an on/off operation by pushing the auxiliary operation member 13 or can adjust the volume or the like of audio equipment by rotating the auxiliary operation member 13. An end part, which is shown on a lower side of FIG. 8, of the auxiliary operation member 13 constitutes a boundary portion 800 which is disposed between the auxiliary operation member 13 and the shaft-side operation member 12 so that this boundary portion 800 is exposed to outside the front panel 1. That is, the two members: the shaft-side operation member 12 and auxiliary operation member 13 are exposed to outside the front panel 1. The operation system of this embodiment thus provides the same beautiful view as shown in FIG. 3.

In this example, when a load W is imposed on the auxiliary operation member 13, lower-strength one of the projections 13b and projections 3b is sheared. Assuming that the projections 13b are sheared, the auxiliary operation member 13 slides only a distance L3 toward the shaft-side operation member 12. After a bottom portion of the auxiliary operation member 13 comes into contact with an upper end of the shaft-side operation member 12, the projections 3b are sheared, and the shaft-side operation member 12 then slides only a distance L2 toward the operating shaft 3. When a tip part of the operating shaft 3 comes into contact with a bottom of the cylinder 12a, the shaft-side operation member 12 stops sliding.

Thus, in this example, since the operation unit experience sliding movements in two steps when shocked, the amount of projection of the operation unit can be reduced greatly. This means that the gap between the substrate 4 and the front panel 1 can be reduced compared with the other structures mentioned above, while the amount of projection (operability) of the knob in a steady state in which the operation unit is under normal operating conditions is secured, and that an exceptional meaning of increasing space efficiency is provided.

Also in this example, instead of the mechanism for making the projections 3b and 13b which are engagement means be sheared when shocked, the operation unit can have a mechanism for making the cylinder 12a and auxiliary operation member 13 respectively corresponding to the projections 3b and 13b become deformed so as to release the engagement between the cylinder and the shaft and the engagement between the shaft-side operation member and the auxiliary operation member. As the engagement means of making the operating shaft 3 be engaged with the cylinder 12a, the combination of the projections 10a2 and the engaging holes 3a2 which are explained with reference to FIGS. 6 and 7 can be used instead of the structure shown in FIG. 8.

### Embodiment 4

In some cases, a solvent, such as grease, can be applied to the operating shaft. When the shaft-side operation member is mounted to such the operating shaft, there is a possibility that solvent cracks occur in the shaft-side operation member depending on the material of the shaft-side operation member and the shaft-side operation member does not have a desired strength due to the cracks. Therefore, in accordance with the present invention, an ABS resin or the like which is resistant to solvents can be used as the material of the shaft-side operation member. On the other hand, such an ABS resin which is resistant to solvents has a property of being sensitive to shocks. Therefore, in accordance with the present invention, when an ABS resin is used as the material of the shaft-side operation member, the operation unit provided with the two operation members makes it possible to select a high-shock-resistant material as the material of the auxiliary operation member. That is, in the structure shown in FIG. 1, 3, 8, or the like, a solvent-resistant material is used as the material of the shaft-side operation member 6 or 12, a shock-resistant material can be used as the material of the auxiliary operation member 7 or 13.

### INDUSTRIAL APPLICABILITY

As mentioned above, an operation system in accordance with the present invention is suitable for use in, for example, a front panel so that a boundary portion disposed between a shaft-side operation member and an auxiliary operation member can be exposed to outside the front panel.

1. An operation system characterized in that an operation unit for operating an operating shaft disposed in an insert hole formed in a front panel is disposed, said operation unit including: a shaft-side operation member attached to said operating shaft; an auxiliary operation member which is fitted into and engaged with said shaft-side operation member via an engagement means for releasing engagement between said shaft-side operation member and said auxiliary operation member when shocked, and which constitutes the single operation unit together with said shaft-side operation member; and a boundary portion disposed between both said operation members with being exposed to outside said front panel when said shaft-side operation member is attached to said operating shaft while being combined with said auxiliary operation member.

2. The operation system according to claim 1, characterized in that the shaft-side operation member is attached to the operating shaft via a shaft engagement means for releasing the engagement between said shaft-side operation member and said operating shaft when shocked.

3. The operation system according to claim 1, characterized in that the shaft-side operation member is made from a solvent-resistant material.
